(19) United States
(12) Patent Application Publication
(10) Pub. No.: US 2007/0271877 A1
(43) Pub. Date: Nov. 29, 2007

(54) Device and Method for Casing, Extracting and Dosing Fibres in Concrete or Mortar

(76) Inventor: Jean Sebille, Pordic (FR)

Correspondence Address: Briggs and Morgan, 80 South Eighth Street, 2400 IDS Center, Minneapolis, MN, 55402, US

(21) Appl. No.: 10/589,172

(22) PCT Filed: Feb. 14, 2005
(86) PCT No.: PCT/FR05/00341

§ 371 Date: Jun. 25, 2007

(30) Foreign Application Priority Data
Feb. 13, 2004 (FR) 0401421

(51) Int. Cl. B65B 9/06; B28C 5/40

(52) U.S. Cl. 53/450; 366/8

(57) ABSTRACT

The invention relates to a device for casing, extracting and dosing fibres. The inventive device is characterised in that it comprises a unit for casing fibres with a constant density in a very long cylindrical plastic bag and a unit for extracting and dosing same during the production of concretes and mortars with fibres. The inventive conditioning enables automated fibre addition for the production of concretes or mortars, while guaranteeing maximum safety in relation to dosing, and facilitates stock management.

The present invention consists of encasing fibres previously cut to various lengths adapted for concrete or mortar with a constant density in a very long cylindrical plastic bag. The latter is coiled so as to form a ring that is placed on a pallet of standard dimensions. The fibres thus encased are wound so as to form a ring that is based on a pallet of standard dimensions.
This packaging makes it possible to automate the addition of fibres to concrete whilst guaranteeing maximum safety on batching and facilitates stock management by writing on the plastic film, every linear metre, a figure by increasing order. It is adapted to all types of vertical or inline concrete plant.
At the present time the fibres are introduced into aggregates by the operator, leaving his workstation, or by the mixing lorry drivers. There is no possibility of checking the exact quantity put in the concrete or mortar manufactured with a precise type of fibre.
In the case of polypropylene fibres, the dose for 1 m³ of concrete or mortar is packaged in a paper or plastic bag of 600 g, 750 g or 900 g for 1 m³ according to the suppliers. The length of the fibres varies according to its intended use for mortar or concrete. The quantity for ¼, ½ or ¾ of m³ is left to the assessment of the person putting in the fibres. The indication on the bags of fibres is not very precise for the recommended use.
Metal fibres are presented in paper bags with a weight of 10 or 20 kg for 1 m³ according to the recommendation of the manufacturer and must be stored away from rain. The dose for 1 m³ of concrete varies from 10 kg to 25 kg according to the stresses on the slab.
Encasing fibres with a plastic film hot welded according to the invention makes it possible to remedy these drawbacks. When the concrete is manufactured, the automatic control system in the plant manages the number of turns of the geared motor and the information from the volume counter of an adjuvant pump. It uncoils the length of cylindrical bag according to the weight of fibres requested in the formula. The quantity of fibres is proportional to the volume manufactured whatever the fraction of m³ manufactured.
The inscription on the delivery note affords traceability in the event of dispute.
The fibres are introduced during the flow of sand and the dispersion thereof is optimised as soon as the weighing start, along with the mixing time.

The ring of encased fibres on the pallet remains stored on the ground outside and is protected by a guardrail.
This packaging protects from rain.
The encasing reduces the cost of the packaging. There is no longer any cardboard or disposable bag.
Stock management is simplified. A single type of fibre serves for several batchings and calculation of the cost of the concrete formula is optimised.

The accompanying drawings illustrate the invention.

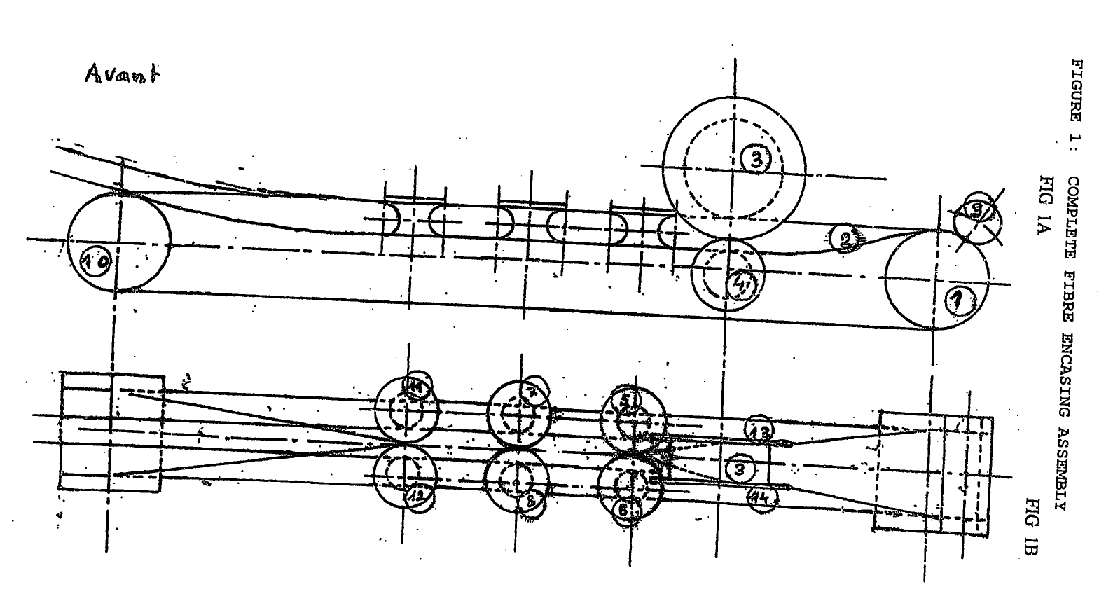

FIGS. 1A and 1B depict the complete device of the invention consisting of encasing the fibres. The rubber belt (2) is driven between two drums (1 and 10). This deforms under the action of rollers with a semicylindrical groove into a cylinder. This guide serves to enclose the fibres in the plastic film.

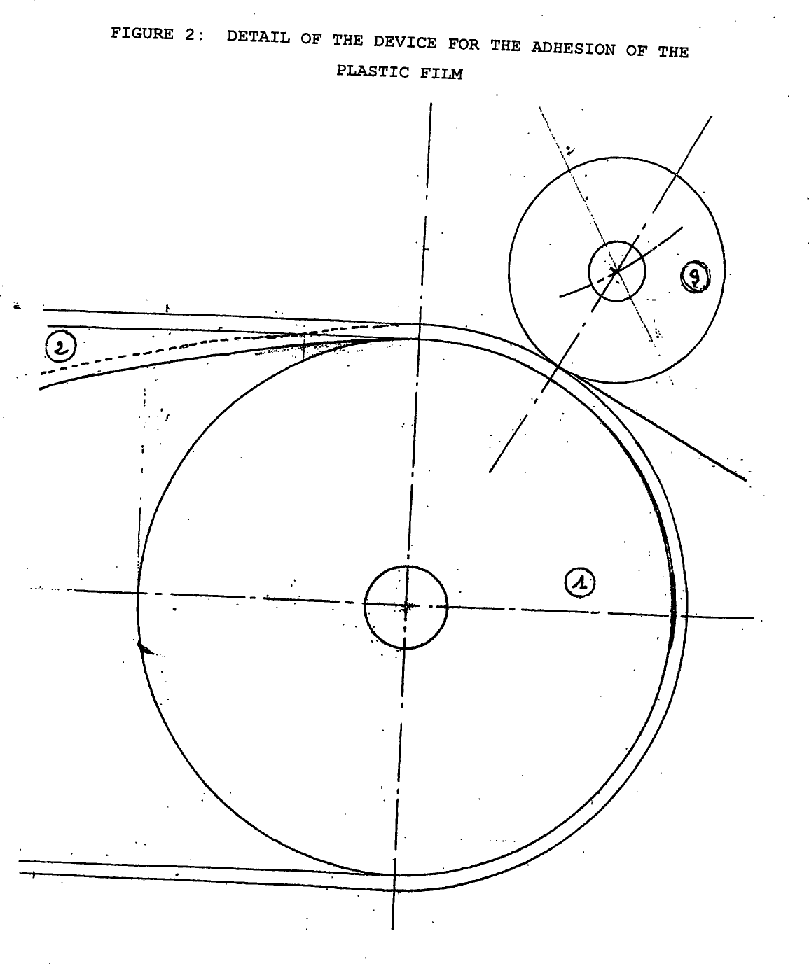

FIG. 2 depicts the device that uncoils the plastic film continuously. A roller (9) exerts a pressure on the plastic film and causes it to adhere to the rubber belt (2).

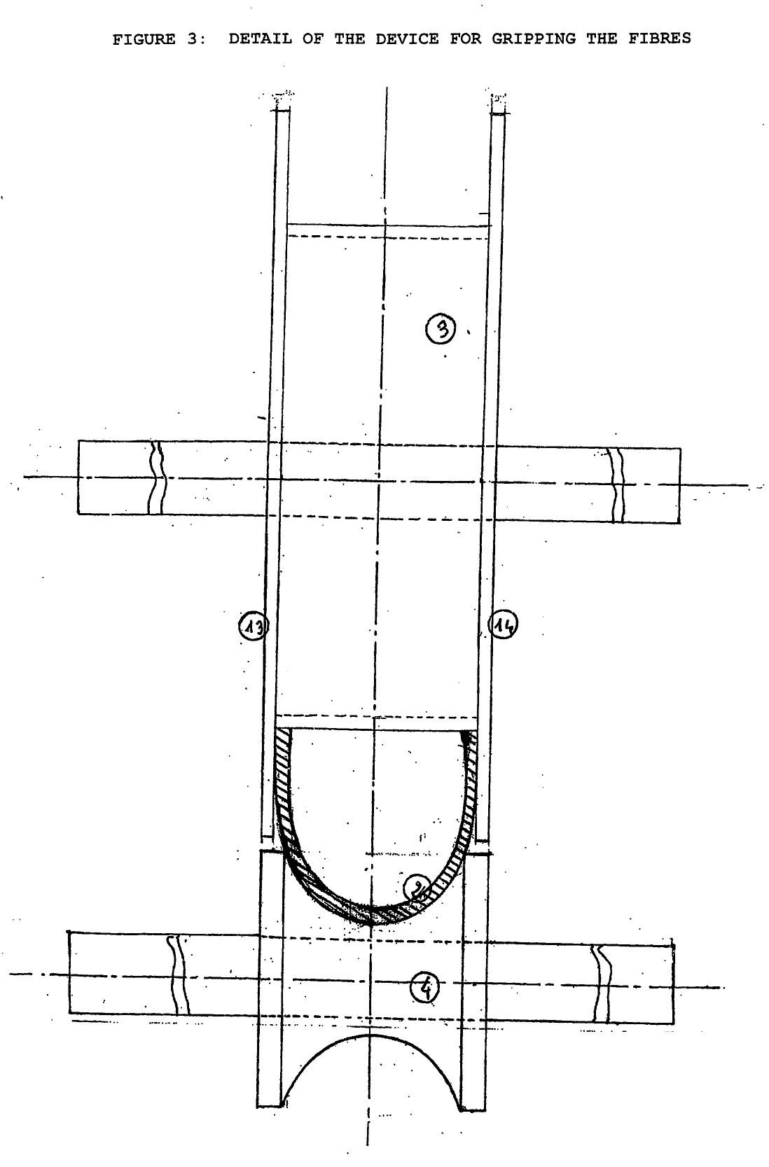

FIG. 3 depicts the device gripping the fibres between the cylinder (3) and the roller (4). The two flanges (13 and 14) push the edges of the plastic film onto the edges of the rubber belt.

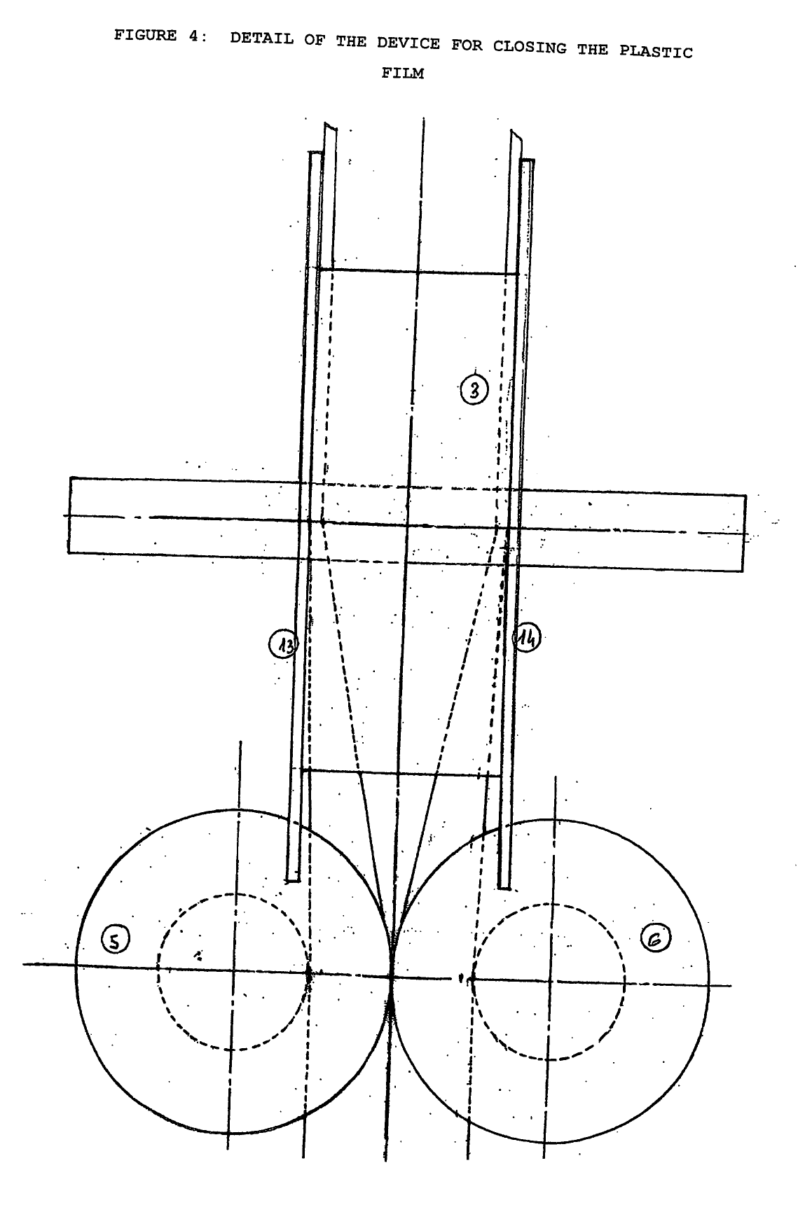

FIG. 4 depicts the device deforming the rubber belt (2) between two rollers (5 and 6) with a semicylindrical groove in order to form a cylinder and causing the two edges of the plastic film to touch each other.

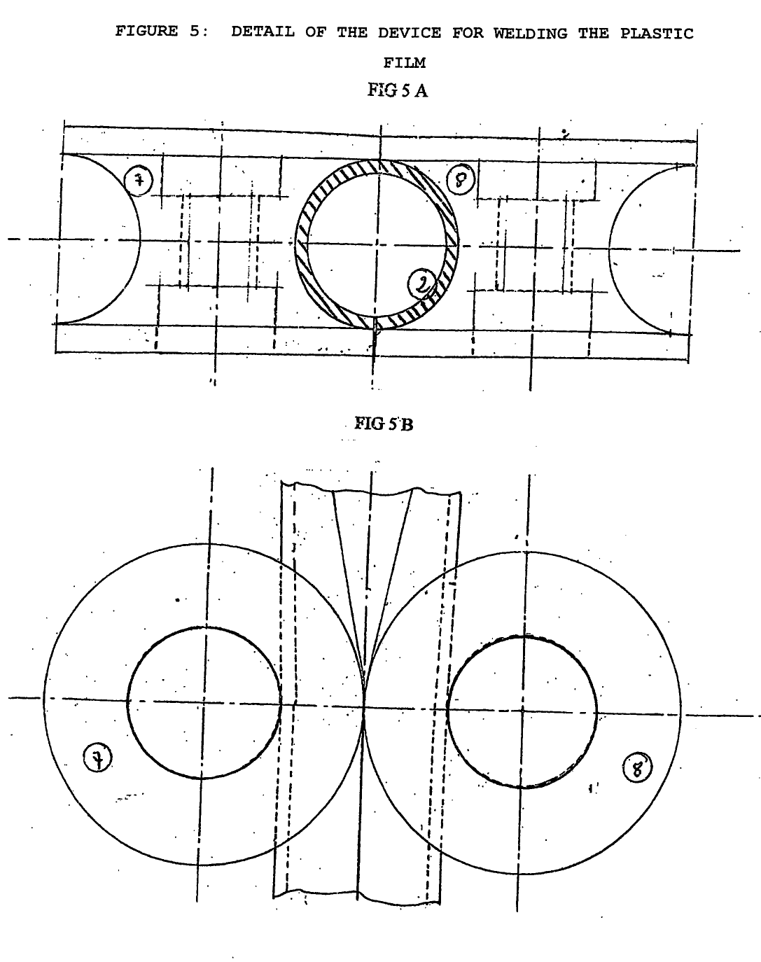

FIGS. 5A and 5B depict the device for maintaining the cylindrical shape making it possible to weld the edges of the plastic film and cooling the plastic film before the coiling of the ring.

With reference to these drawings, the device comprises a frame on which two drums are mounted. The front drum (10) is driven by a geared electric motor whose speed is calculated according to the continuous feed of the fibres. The latter are gripped between a wheel (3) provided with two flanges (13 and 14) and a roller (4) placed under the rubber belt (2). The plastic film is wider than the rubber belt. The two flanges (13 and 14) push the edges of the plastic film back onto the edges of the belt. A sensor placed at the rear of the wheel checks the quantity of fibres enclosed in the plastic film. The rollers with semicylindrical groove deform the belt into a cylinder. The first two (5 and 6) guide the plastic film. The following two (7 and 8) weld them hot through the pressure of the top part of the rollers. The last two (11 and 12) hold the plastic film in the belt during its cooling.

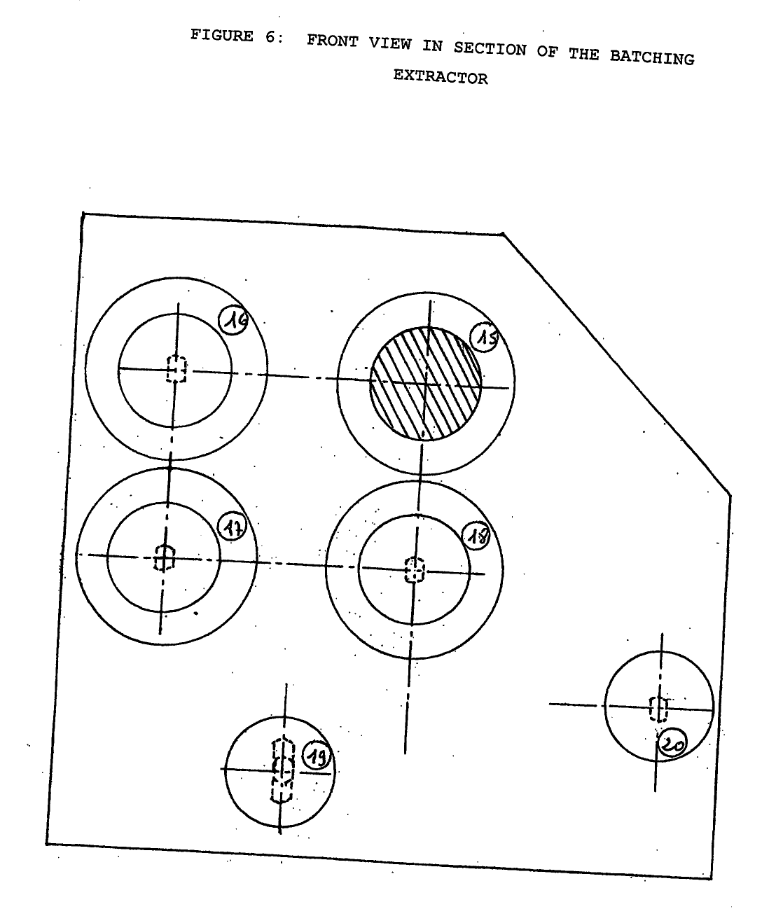

FIG. 6 depicts the device of the invention for the extraction and batching of the encased fibres and the chopping of the plastic sheath in front view.

The four rollers (15, 16, 17 and 18) are connected together rotationally by a chain. This is kept under tension by the bottom roller (19).

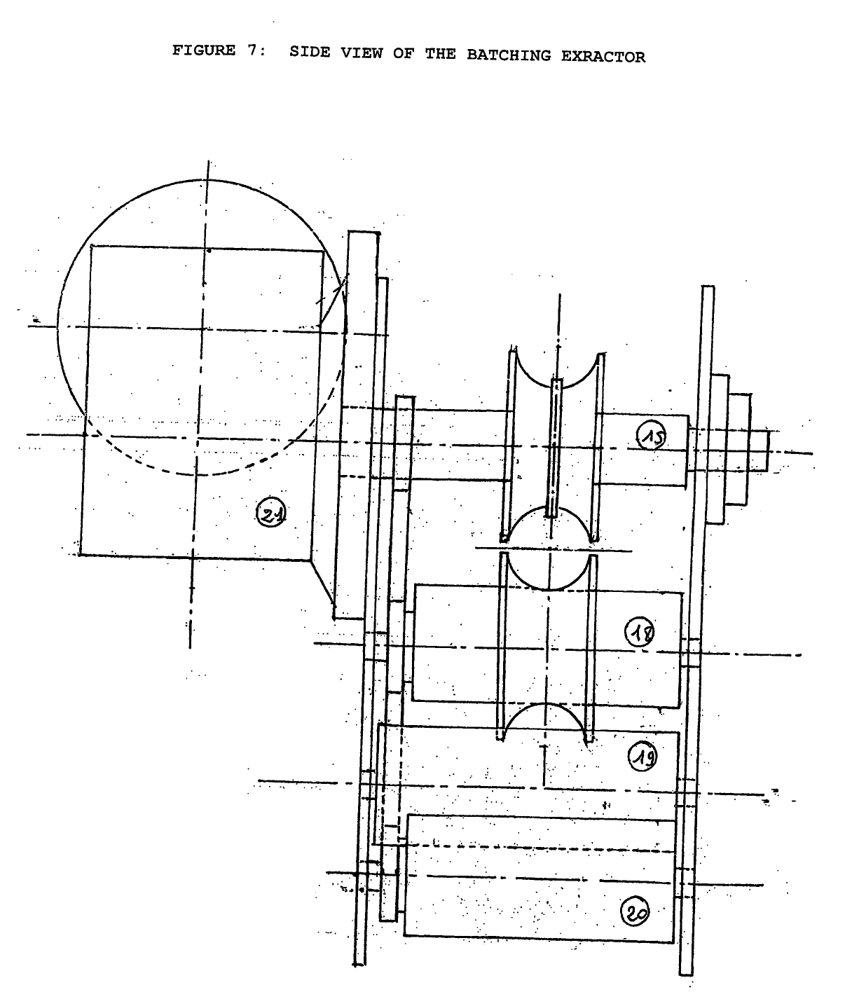

FIG. 7 depicts the device of the invention for the extraction and batching of the encased fibres and the chopping of the plastic case seen from the side. The four rollers (15, 16, 17 and 18) with a semicylindrical groove drive the plastic bag full of fibres. An electrical detector counts the number of turns on the electric motor that drives the gearbox (21). The top roller (15) provided with a cutting disc splits the plastic film and releases the fibres. The film is then ground after it leaves the roller (19).

With reference to these drawings, the device comprises four rollers (15, 16, 17 and 18) with a semicylindrical groove that extract the bags of fibres through the centre of the ring. A metal lug fixed to the fan of the electric geared motor, passing in front of an electrical detector, give the number of turns thereof. This information is managed, along with that of the volume counter of an adjuvant pump, by the automatic control system of the concrete plant. The front top roller (15) provided with a cutting disc chops the plastic sheath, which spreads over the font drum (20) and serves as a support for the fibres until they are tipped onto the aggregates. The plastic film is taken up by the bottom drum (19). It is then ground and falls into the aggregates.

By way of non-limiting example, the plastic bag has a diameter of around 6 cm and is coiled on a standard pallet. The length of the ring can be 250 m or 500 m according to the consumption of the concrete plant.
The ring, protected by an anti-ultraviolet plastic film, is stored on the ground at the concrete plant. The encased fibres are extracted through the centre vertically as far as the return pulley situated level with the aggregate scales. The latter has a sufficient diameter to prevent the breaking of the plastic film and is mounted on a bearing preventing reverse rotation in order to limit traction during the stoppage of the batching extractor. They are then pulled horizontally by the rollers of the batching extractor.

1. Device for the encasing, extraction and batching of fibres, characterised in that it comprises a unit for encasing the fibres with a constant density in a long cylindrical plastic bag and a unit for extracting and batching these during the manufacture of concrete or mortar with fibres.

2. Device according to claim 1, characterised in that it comprises two drums that drive a rubber belt deformed between rollers in order to form a cylinder, the latter serves as a guide for the plastic film during its hot welding and prevents its deformation before complete cooling thereof.

3. Device according to claim 1 or 2, consisting of the fact that the extraction and batching unit comprises a metal lug fixed to the fan of the electric geared motor that passes in front of the electrical detector and gives the number of its turns by driving the rollers of the batching extractor.

4. Device according to one of claims 1 to 3, consisting of the fact that the extraction and batching unit comprises a return pulley with sufficient diameter to prevent the breaking of the plastic film and mounted on a bearing preventing reverse rotation for limiting traction during the stoppage of the batching extractor.

5. Method for encasing fibres by means of a device according to claim 2, characterised by the driving of a rubber belt that deforms between rollers in order to enclose the fibres previously cut to the various lengths in a plastic film with a constant density and welding it continuously.

6. Method for encasing fibres according to claim 5, characterised by the writing on the plastic film of a figure in increasing order every linear metre when then coiling of each ring starts, which makes it possible to know the consumption of fibres in the ring in order to facilitate stock management.

7. Method for encasing fibres by means of a device according to claim 3, characterised in that it consists of counting the number of turns of the electric motor driving the rollers of the batching extractor which gives the information to the automatic controller of the concrete plant and manages it along with that of the volume counter of an adjuvant pump.

8. Method for extracting and batching fibres according to claim 7, characterised in that it consists of splitting the plastic case by means of the cutting disc simultaneously with the batching of the fibres.

9. Method for extracting and batching fibres according to claim 7 or 8, characterised in that it consists of grinding the plastic sheath simultaneously with the batching of the fibres and its incorporation in the aggregates.
